(19) United States
(12) Patent Application Publication
(10) Pub. No.: US 2014/0229782 A1
(43) Pub. Date: Aug. 14, 2014

(54) Automatic Test Equipment

(71) Applicants: Jochen Rueter, Donzdorf (DE); Simone Rehm, Ehningen (DE); Joerg-Walter Mohr, Eutingen (DE); Frank Hensel, Stuttgart (DE)

(72) Inventors: Jochen Rueter, Donzdorf (DE); Simone Rehm, Ehningen (DE); Joerg-Walter Mohr, Eutingen (DE); Frank Hensel, Stuttgart (DE)

(21) Appl. No.: 14/259,043

(22) Filed: Apr. 22, 2014

Related U.S. Application Data
(63) Continuation of application No. PCT/EP2011/068677, filed on Oct. 25, 2011.

(51) Int. Cl. G06F 11/27

(52) U.S. Cl. CPC G06F 11/27
USPC 714/733

(57) ABSTRACT

Embodiments of the present invention provide an automatic test equipment. The automatic test equipment is configured to receive an input signal from a device under test and to write an information describing the input signal to a memory. The automatic test equipment is further configured to read the information describing the input signal from the memory and to provide an output signal for the device under test based on the information describing the input signal read from the memory.

### CROSS-REFERENCE TO RELATED APPLICATIONS

This application is a continuation of copending International Application No. PCT/EP2011/068677, filed Oct. 25, 2011, which is incorporated herein by reference in its entirety.

Embodiments of the present invention relate to an automatic test equipment. Some embodiments of the present invention relate to a BIST loopback by memory based capture and replay (BIST=built-in self test).

### BACKGROUND OF THE INVENTION

Loopbacks are used in the testing of serial and parallel links in production. Thereby, the simplest loopback is based on a cable loopback or a load board loopback. This has low initial cost and enables to take advantage of DFT/BIST testing (DFT=Design for Test). Moreover, a better fault coverage can be achieved by using a parameterized loopback as offered in most ATE solutions (ATE=Automatic Test Equipment). Almost all new high-speed standards define a DFT/BIST mode, which enables the ATE to take advantage of those capabilities using loopback.

Motivations for loopback solutions are the time to test, e.g. no engineering effort is required to setup patterns in the ATE, that the DUT internal BIST engine has a higher test coverage (DUT=Device Under Test), and that the DUT internal BIST engine can control the test. In addition, due to the analog behavior of the links, a parameterized loopback testing is enabled, such as DC measurement, at-speed level verification and jitter tolerance test.

Advantages of a parameterized loopback compared to a load board loopback are greater or enhanced test capabilities similar to those offered by an ATE channel, signal conditioning and/or stressing and higher fault coverage, e.g. jitter injection, DC at-speed level verification and jitter tolerance test.

FIG. 1 shows a block diagram of a DUT 10 and a known load board 12 based loopback 14 for testing the DUT 10 (DUT=Device Under Test). The DUT 10 comprises a BIST unit 16 (JO cell DFT), a driver 18 and a receiver 20. The BIST-unit 16 comprises a pattern generator 22 (PATGEN) and a BERT unit 24 (BERT=Bit Error Rate Test).

In the loopback path 14 shown in FIG. 1 no ATE tester 26 is involved. The loopback 14 on the load board 12 is used to connect the driver 18 and the receiver 20 of the DUT 10. Thereby, the BIST circuit 16 in the DUT 10 is used to test the driver 18 and the receiver 20 of the DUT 10 together.

FIG. 2 shows a block diagram of the DUT 10 and a known parameterized loopback 14 for testing the DUT 10. As shown in FIG. 2, the loopback path 14 comprises an ATE 26 having a receiver 28, a jitter/DC measurement unit 30, a retiming unit 32, a jitter/skew injection unit 34 and a driver 36. The ATE 26 is configured to receive a signal from the DUT 10 with a given threshold, to measure DC and jitter (of the signal), to retime the signal and to drive the signal to the DUT 10 with a defined jitter and/or skew.

Thereby, the tester driver (driver channel 37) can be configured to generate a captured pattern continuously (as long as other digital pattern run) and to perform a jitter injection. The tester receiver (receiver channel 29) can be configured to capture a pattern continuously, to provide source data for drive (as long as other digital pattern run; wrap around) and to measure a jitter via a time stamper (TIA).

FIG. 3 shows a block diagram of the DUT 10 and a known digital drive/receive path loopback 14 for testing the DUT 10. In contrast to FIG. 2, the ATE 26 further comprises a first channel memory 42 and a second channel memory 44.

Thereby, the tester driver (drive channel 37) is configured to perform a generic pattern generation, e.g. Pseudo Random Bit Sequence, PRBS, and to perform a jitter injection as timing stress. The tester receiver (receive channel 29) is configured to perform a generic pattern compare, an error count and an edge sweep in order to find the optimum timing.

### SUMMARY

According to an embodiment, an automatic test equipment is configured to receive an input signal from a device under test and to write an information describing the input signal to a memory; and to read the information describing the input signal from the memory and to provide an output signal for the device under test based on the information describing the input signal read from the memory; and the device under test has a built in self test unit, wherein the automatic test equipment is coupled to the device under test to receive a signal provided by the built in self test unit as the input signal and to provide the output signal to the built in self test unit.

According to another embodiment, a method for testing a device under test having a built in self test unit may have the steps of: receiving an input signal from the device under test and writing an information describing the input signal to a memory; and reading the information describing the input signal from the memory and providing an output signal for the device under test based on the information describing the input signal read from the memory; wherein receiving the input signal includes receiving a signal provided by the built in self test unit as the input signal; and wherein providing the output signal includes providing the output signal to the built in self test unit of the device under test.

Another embodiment may have a computer program for testing a device under test, the computer program having a program code for performing, when running on a computer or microprocessor, a method according to claim 15.

According to another embodiment, in an apparatus for configuring an automatic test equipment, the apparatus is adapted to configure the automatic test equipment to receive an input signal from a device under test and to write an information describing the input signal to a memory; and the apparatus is adapted to configure the automatic test equipment to read the information describing the input signal from the memory and to provide an output signal for the device under test based on the information describing the input signal read from the memory; and the device under test has a built in self test unit, wherein the automatic test equipment is coupled to the device under test to receive a signal provided by the built in self test unit as the input signal and to provide the output signal to the built in self test unit.

According to another embodiment, a method for configuring an automatic test equipment may have the steps of: configuring the automatic test equipment to receive an input signal from a device under test and to write an information describing the input signal to a memory; and configuring the automatic test equipment to read the information describing the input signal from the memory and to provide an output signal for the device under test based on the information describing the input signal read from the memory; wherein the device under test has a built in self test unit, wherein the automatic test equipment is coupled to the device under test to receive a signal provided by the built in self test unit as the input signal and to provide the output signal to the built in self test unit.

Another embodiment may have a computer program for configuring an automatic test equipment, the computer program having a program code for performing, when running on a computer or microprocessor, a method according to claim 18.

According to another embodiment, an automatic test equipment system may have an automatic test equipment according to claim 1 and a device under test, wherein the device under test has a built in self test unit, wherein the automatic test equipment is coupled to the device under test to receive a signal provided by the built in self test unit as the input signal and to provide the output signal to the built in self test unit.

Embodiments of the present invention provide an automatic test equipment that is configured to receive an input signal from a device under test and to write an information describing the input signal to a memory. The automatic test equipment is further configured to read the information describing the input signal from the memory and to provide an output signal for the device under test based on the information describing the input signal read from the memory.

According to the concept of the present invention, a loopback between driver and receiver of the device under test is provided by storing an information describing the input signal to the memory, and by providing an output signal based on the information describing the input signal stored on the memory.

### BRIEF DESCRIPTION OF THE DRAWINGS

Embodiments of the present invention will be detailed subsequently referring to the appended drawings, in which:

FIG. 1 shows a block diagram of a DUT and a known load board based loopback for testing the DUT;

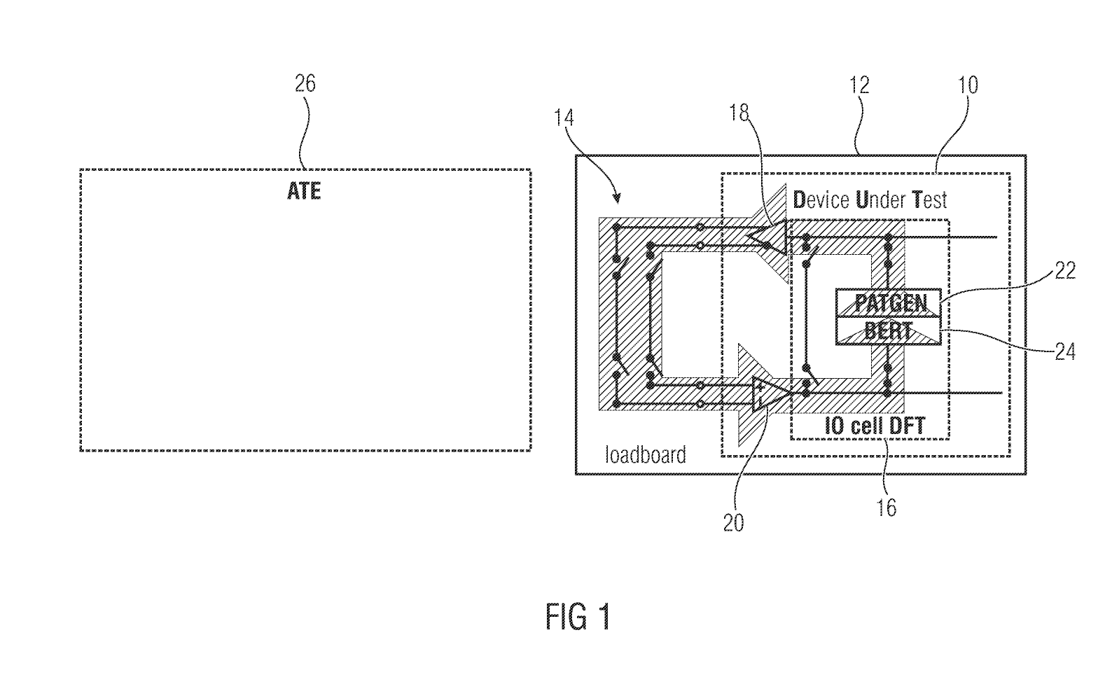

FIG. 2 shows a block diagram of the DUT and a known parameterized loopback for testing the DUT;

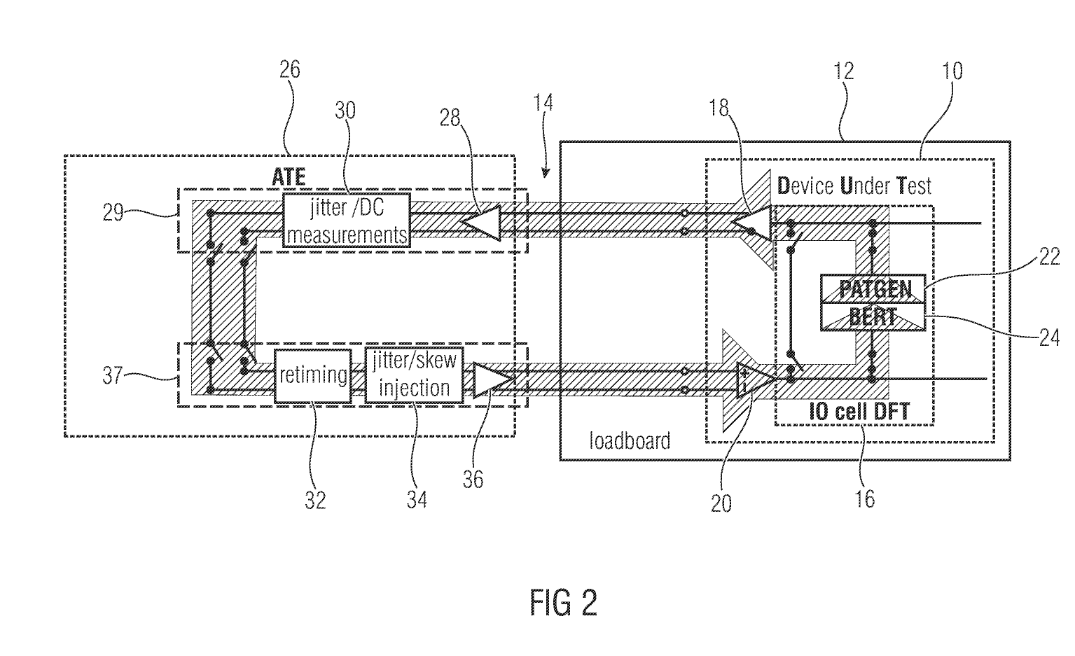

FIG. 3 shows a block diagram of the DUT and a known digital drive/receive path loopback for testing the DUT;

FIG. 4 shows a block diagram of an automatic test equipment according to an embodiment of the present invention;

FIG. 5a shows a block diagram of the automatic test equipment shown in FIG. 4 further comprising a first channel and a second channel according to an embodiment of the present invention;

FIG. 5b shows a block diagram of the automatic test equipment shown in FIG. 5a further comprising a second memory according to an alternative embodiment of the present invention;

FIG. 6 shows a block diagram of an automatic test equipment system according to an embodiment of the present invention;

FIG. 7 shows a block diagram of the automatic test equipment system according to an embodiment of the present invention; and

FIG. 8 shows an illustrative view of a FIFO based memory allocation of the memory according to an embodiment of the present invention.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

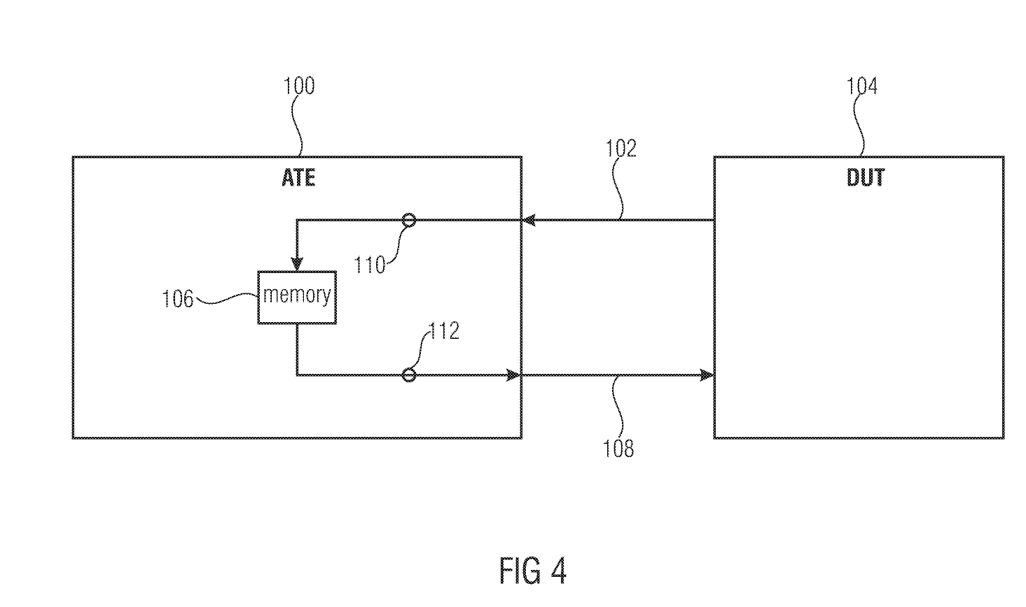

FIG. 4 shows a block diagram of an automatic test equipment 100 according to an embodiment of the present invention. The automatic test equipment 100 is configured to receive an input signal 102 from a device under test 104 and to write an information describing the input signal 102 to a memory 106. The automatic test equipment 100 is further configured to read the information describing the input signal 102 from the memory 106 and to provide an output signal 108 for the device under test 104 based on the information describing the input signal 102 read from the memory 106.

In embodiments, the automatic test equipment 100 is configured to provide a loopback for the input signal 102 received from the device under test 104 by storing an information describing the input signal 102 to the memory 106 and by providing an output signal 108 for the device under test 104 based on the information describing the input signal 102 stored on the memory 106. In other words, in embodiments, the output signal 108 can be a (delayed) loopback of the input signal 102.

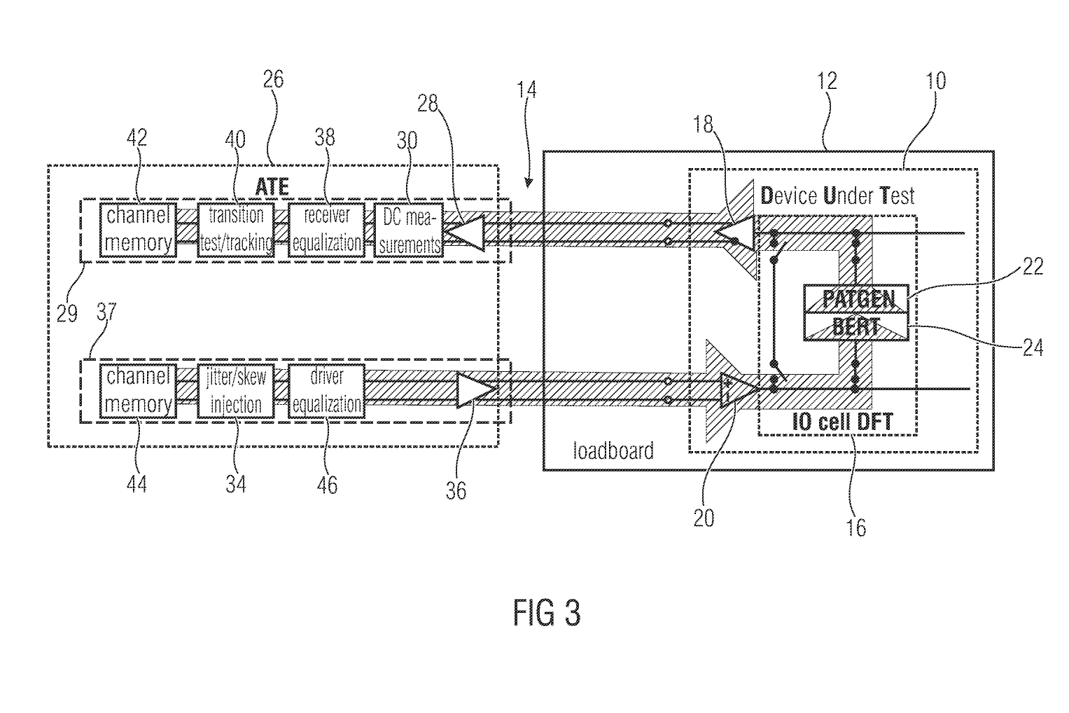

In other words, the approach according to the concept of the present invention is that generic building blocks of the ATE 100 are used in a new way. For example, the memories 42 and 44 shown in FIG. 3 can be combined in order to provide the loop back mode of data generated by DUT 104 logic back into the device for evaluation without the need of an extra signal path either on the DUT 104 load board or inside the ATE 100 pin electronics as shown in FIG. 4.

The automatic test equipment 100 can be configured to write the information describing the input signal 102 to the memory 106 such that the information describing the input signal 102 are vectors describing the input signal 102. In embodiments, the data storage format can depend on whether the user chooses to have “electrical idle detection” on or off In the case that the user chooses to have “electrical idle detection” off, only two states of the DUT signal may be captured by the receiver and forwarded to the driver, namely low and high. Therefore, one bit per sample can be enough to capture the DUT state. A “low” state can be represented by 0, a “high” state can be represented by 1. In the case that the user chooses to have “electrical idle detection” on, three states of the DUT signal can be captured, namely low, intermediate and high. Two bits per sample may be used for storing DUT state. A “low” can be represented by 00, a “high” can be represented by “01”, and an “intermediate” can be represented by “10”. In some embodiments, both modes can be mixed.

In embodiments, an input path 110 of the automatic test equipment 100 can be configured to convert the input signal 102 into a digital signal using an adjustable sample frequency and an adjustable threshold level in order to obtain the information describing the input signal 102. An output path 112 of the automatic test equipment 100 can be configured to provide the output signal 108 using an adjustable clock edge and an adjustable signal level based on the information describing the input signal 102 read from the memory 106.

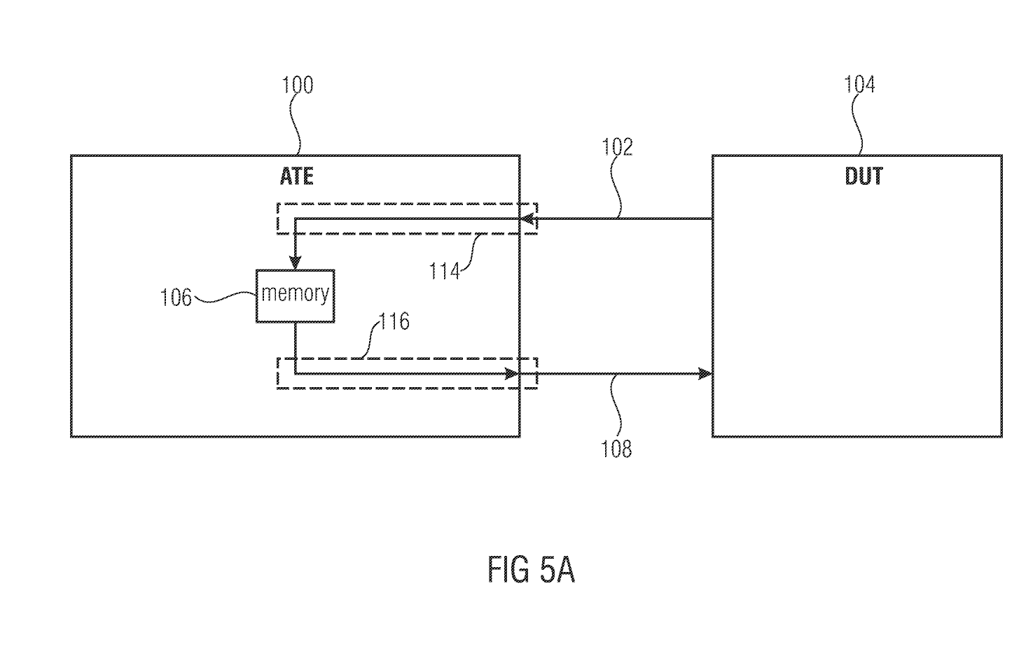

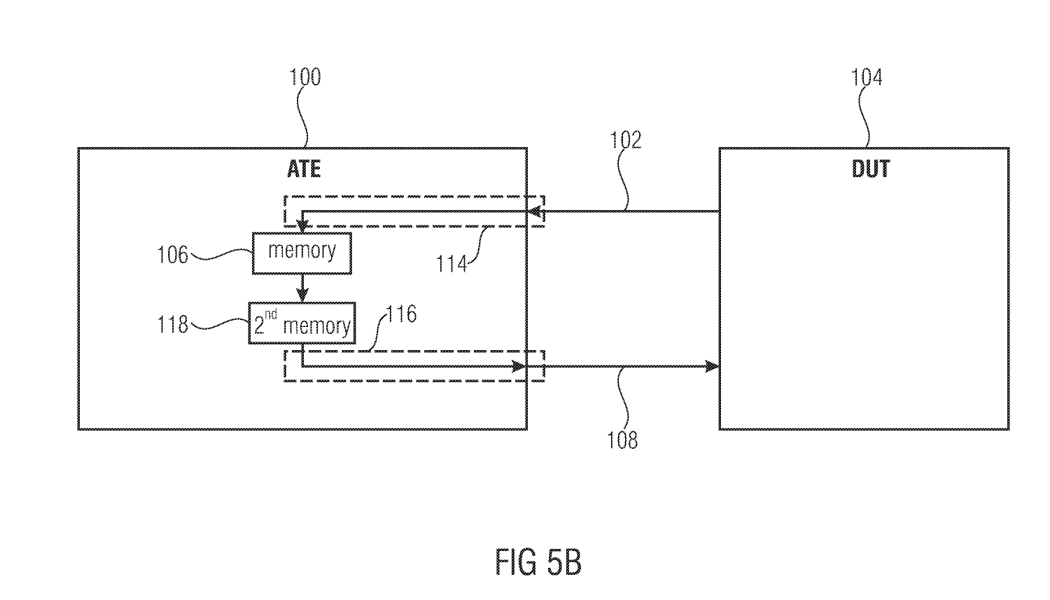

In the following, alternative implementation examples of the automatic test equipment 100 according to the concept of the present invention are described making reference to FIGS. 5a and 5b.

FIG. 5a shows a block diagram of the automatic test equipment 100 shown in FIG. 4 further comprising a first channel 114 and a second channel 116 according to an embodiment of the present invention. The first channel 114 can be configured to receive the input signal 102 from the device under test 104 and to write the information describing the input signal 102 to the memory 106. The second channel 116 can be configured to read the information describing the input signal 102 from the memory 106 and to provide the output signal 108 for the device under test 104 based on the information describing the input signal 102 read from the memory 106.

FIG. 5b shows a block diagram of the automatic test equipment 100 shown in FIG. 5a further comprising a second memory according to an alternative embodiment of the present invention. The first channel 114 is configured to receive the input signal 102 from the device under test 104 and to write the information describing the input signal 102 to the memory 106. The second memory 118 is linked to the first memory 106 for copying the information describing the input signal 102 from the memory 106 to the second memory 118. The second channel 116 is configured to read the information describing the input signal 102 from the second memory 118 and to provide the output signal 108 for the device under test 104 based on the information describing the input signal 102 read from the second memory 118.

Referring to FIGS. 5a and 5b, the first channel 114 and/or the second channel 116 can be differential channels. In addition, the first channel 114 and/or the second channel 116 can be bidirectional channels, i.e. the first channel 114 can be further configured to provide an output signal for the device under test 104, wherein the second channel 116 can be further configured to receive an input signal from the device under test. Moreover, in embodiments, the first channel 114 can be the input path 110, wherein the second channel can be the output path 112 described regarding the embodiment of the automatic test equipment shown in FIG. 4.

The automatic test equipment 100 can comprise a measurement unit for measuring a parameter of the input signal 102. For example, the measurement unit can be configured to perform a jitter measurement, DC measurement (DC=Direct Current) and/or a transition test measurement. Referring to the exemplary embodiments shown in FIGS. 5a and 5b, the first channel 114 can comprise the measurement unit. Moreover, both channels 114 and 116 can comprise the (same) measurement unit, i.e. when the direction of the loopback is inverted, also the second channel 116 can comprise the measurement unit. In addition channels 114 and 116 can change roles at any time or change back into standard ATE pattern execution.

Moreover, the automatic test equipment 100 can further comprise a modification unit for modifying a parameter of the output signal 108. For example, the modification unit can be configured to perform a jitter injection and/or a skew injection. Referring to the exemplary embodiments shown in FIGS. 5a and 5b, the second channel 116 can comprise the modification unit. Moreover, both channels 114 and 116 can comprise the (same) modification unit, i.e. when the direction of the loopback is inverted, also the second channel 116 can comprise the modification unit. In addition channels 114 and 116 can change roles at any time or change back into standard ATE pattern execution.

Furthermore, the automatic test equipment 100 can further comprise a retiming unit for detecting a timing of the input signal 102 and for retiming the output signal 108. In addition, the retiming unit can be configured to retime the output signal 108 based on the timing of the input signal 102. Alternatively, the retiming of the output signal 108 can be given by the automatic test equipment 100. Referring to the exemplary embodiments shown in FIGS. 5a and 5b, the second channel 116 can comprise the retiming unit. Naturally, in other embodiments, the first channel 114 can comprise the retiming unit. In addition, the automatic test equipment 100 can comprise an equalization unit for equalizing the input signal 102 and/or an equalization unit for equalizing the output signal 108. Referring to the exemplary embodiments shown in FIGS. 5a and 5b, the first channel 114 can comprise the equalization unit for equalizing the input signal 102, wherein the second channel 116 can comprise the equalization unit for equalizing the output signal 108.

In the following, the functionality of the automatic test equipment 100 is described by means of an exemplary embodiment of an automatic test equipment system comprising the automatic test equipment 100 according to the concept of the present invention and a device under test 104.

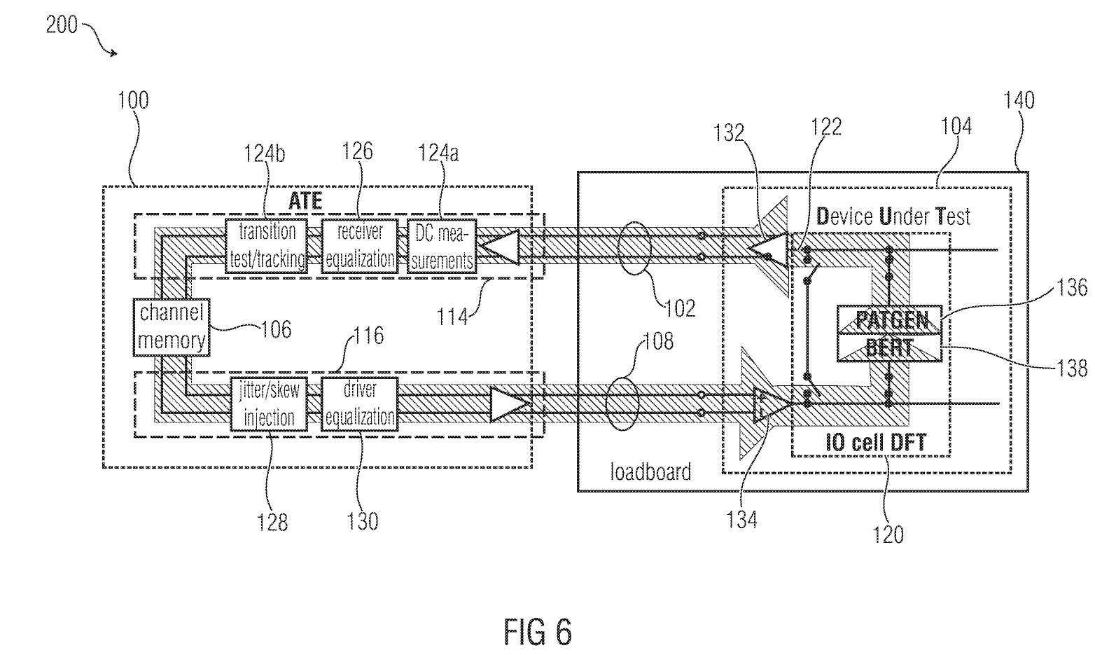

FIG. 6 shows a block diagram of an automatic test equipment system 200 according to an embodiment of the present invention. The automatic test equipment system 200 comprises the automatic test equipment 100 described regarding to the embodiments shown in FIGS. 4, 5a and 5b, and the device under test 104. The device under test 104 can comprise a built-in self test unit 120 (IO cell DFT), wherein the automatic test equipment 100 is coupled to the device under test 104 to receive a signal 122 provided by the built-in self test unit 120 as the input signal 102 and to provide the output signal 108 to the built-in self test unit 120.

Furthermore, as shown in FIG. 6, the device under test 104 can comprise a driver 132 and a receiver 134, wherein the BIST unit 120 can comprise a pattern generator 136 and a BERT unit 138 (BERT=Bit Error Rate Test). As exemplarily shown in FIG. 6, the automatic test equipment 100 can be coupled to the device under test 104 by means of a load board 140.

The automatic test equipment 100 can comprise a first channel 114, a memory 106 and a second channel 116. The first channel can be configured to receive the input signal 102 from the device under test 104 and to write the information describing the input signal 102 to the memory 106. The second channel 116 can be configured to read the information describing the input signal 102 from the memory 106 and to provide the output signal 108 for the device under test 104 based on the information describing the input signal 102 read from the memory 106. As exemplarily shown in FIG. 6, the first channel 114 and the second channel 116 can be differential channels.

The first channel 114 (receive channel or loopback receive channel) can comprise a measurement unit 124 for measuring a parameter of the input signal 102. As exemplarily shown in FIG. 6, the measurement unit 124 can comprise a DC measurement unit 124a and a transition test/tracking measurement unit 124b. Furthermore, the first channel 114 can comprise an equalization unit 126 (receiver equalization) configured for equalizing the input signal 102. Furthermore, the first channel 114 can also comprise a time measurement unit configured to perform a time measurement.

The second channel 116 (drive channel or loopback drive channel) can comprise a modification unit 128 for modifying the output signal 108. As shown in FIG. 6, the modification unit 128 can be configured to perform a jitter injection and/or skew injection. Furthermore, the second channel 116 can comprise an equalization unit 130 (driver equalization) configured for equalizing the output signal 108.

In other words, FIG. 6 shows a memory based loopback, where the loopback is performed by capturing the received signal 102 in memory 106 and replaying data from the memory 106 on the drive path 116. Thereby, the channels 114 and 116 can have access to a common memory area 106 or be able to fast copy data between memories 106 and 118 (e.g. as shown in FIG. 5b). The DUT stream 102 can be captured in the memory 106 where the captured data can be used as a vector/signal for driving data to the DUT 104. In addition, the automatic test equipment 100 can support a clock data recovery (CDR) and/or a tracking of the receive DUT signal.

An advantage of the integration of the loop back capability into the ATE 100 pin electronics is that this way a seamless switching between classical ATE mode and loop mode is enabled. ATE mode is aimed to verify the device under test (DUT) 104 by means of stimulus and response and compares this against specifications set (e.g. in pattern content, levels, timing etc.) The loop mode is the counterpart to built-in self test (BIST) 120 capabilities of the DUT 104 design, which are aimed to verify from inside the device that the building blocks can work and function together as a whole. Without integration of a loop mode into the ATE 100 additional relays on the DUT 104 load board 140 may facilitate this, leading to additional costs in load board 140 manufacturing.

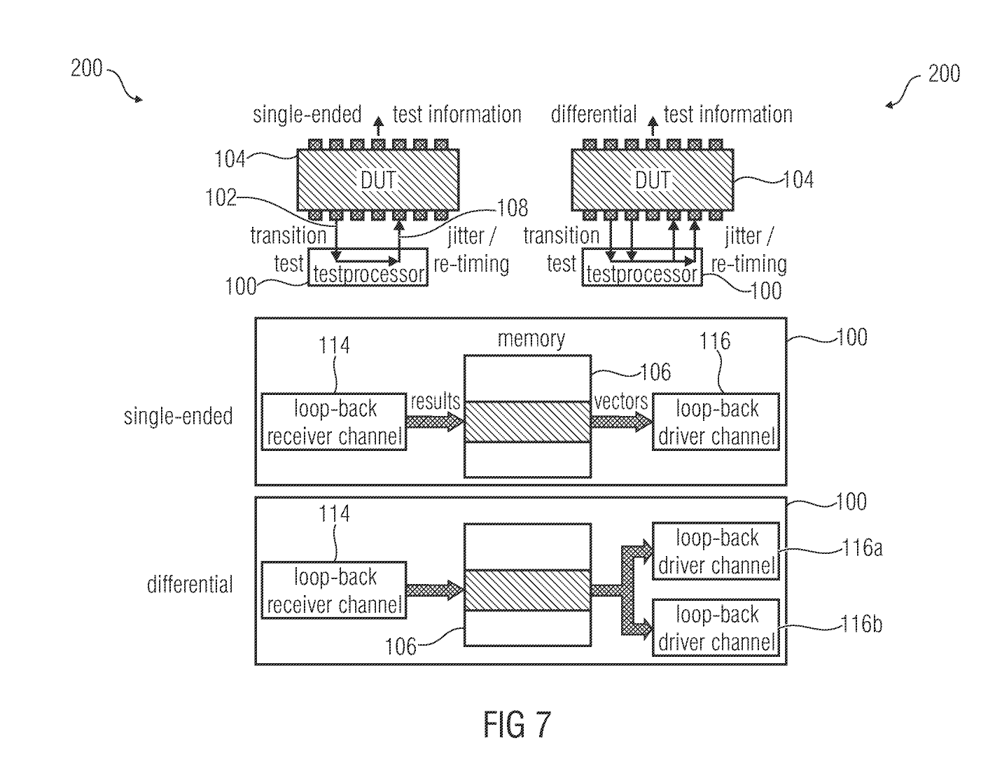

FIG. 7 shows a block diagram of the automatic test equipment system 200 according to an embodiment of the present invention. As exemplarily shown in FIG. 7a, the automatic test equipment 100 can be implemented as a test processor 100. Naturally, the automatic test equipment can also be implemented by means of other implementations, such as an FPGA (FPGA=Field Programmable Gate Array) or ASIC (ASIC=Application Specific Integrated Circuit). The test processor 100 can have single ended channels 114 and 116, where the device under test 104 is coupled to the test processor 100. The test processor 100 can be configured to receive the input signal 102 from the DUT 104 (first channel 114) and to provide the output signal 108 for the device under test 104 (second channel 116) as already explained in detail in the above embodiments. Thereby, the test processor 100 can be configured to provide the functionality of the measurement unit 124, the modification unit 128, the retiming unit and the equalization unit. Hence, the test processor 100 can be configured to perform, for example, a measurement of the input signal 102, a jitter injection in the output signal 108 and/or a retiming of the output signal 108, where those measurements can be performed in parallel to loopback, thereby providing the advantage of test time reduction.

Moreover, as shown in FIG. 7, the test processor 100 can be reconfigured to have differential channels 114 and 116. In addition, the test processor 100 can be reconfigurable to either operate single-ended or differential.

In the case that the test processor 100 is configured to provide single-ended channels 114 and 116, the loopback receiver channel 114 can be configured to write the information describing the input signal 102 to the memory 106, where the loopback driver channel 116 can be configured to read the information describing the input signal 102 from the memory 106.

Moreover, as shown in FIG. 7, the test processor 100 can be configured or reconfigured to have or provide two loopback driver channels 116a and 116b for differential applications.

In other words, FIG. 7 illustrates the memory based loopback according to the concept of the present invention (e.g. memory pooling). Thereby, one memory area (of the memory 106) can be shared between channels 114 and 116. The loopback receiver channel 114 can capture data in a format that can be interpreted as a vector by the loopback driver channel 116. Moreover, for differential applications, two loopback driver channels 116a and 116b for the positive and negative leg source vectors from the result area of the loopback receiver channel(s) 114 can be used.

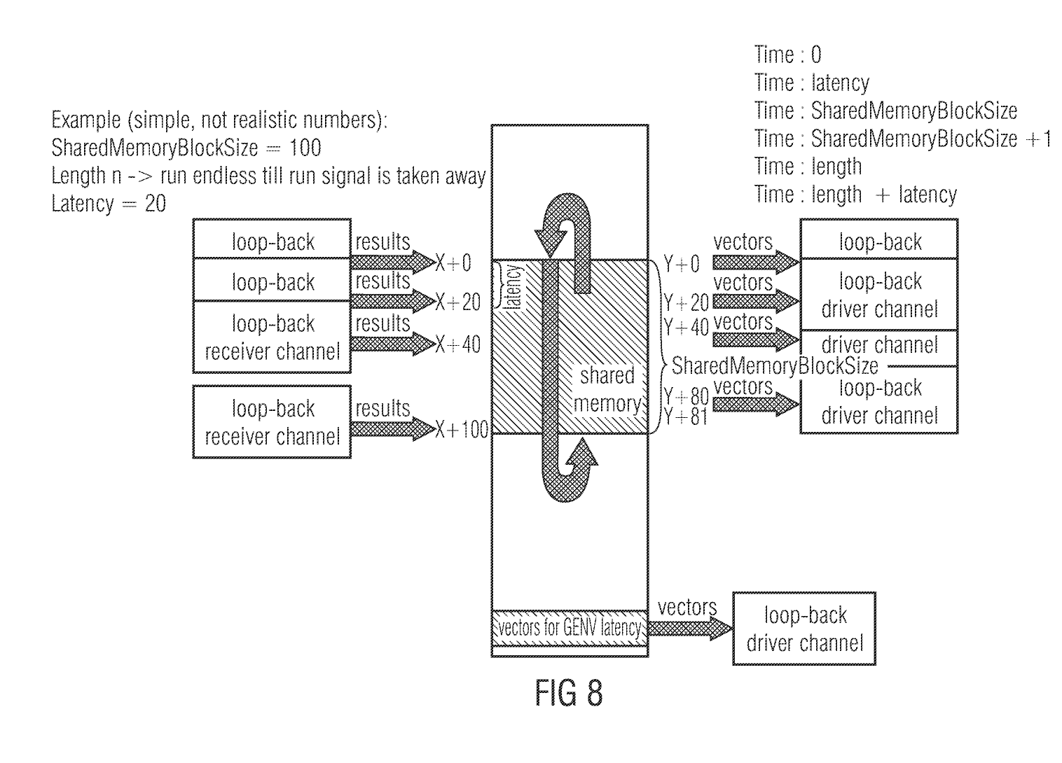

FIG. 8 shows an illustrative view of a FIFO based memory allocation of the memory 106 according to an embodiment of the present invention (FIFO=First In First Out). In FIG. 8, the SharedMemoryBlockSize is exemplarily chosen to be 100 cycles, where the constant latency is assumed to be 20 cycles (note that these are exemplary, not realistic numbers). In embodiments, a cycle can be a single addressable memory cell, containing a single data element. Moreover, a cycle (=tester cycle) can be configured to a certain time, e.g. 1 tester cycle=1 ns. 1 tester cycle can capture multiple bits to memory, e.g. 8 bits. 100 tester cycles then can occupy 800 bit/100 byte of tester memory.

In the following, the FIFO based memory allocation of the memory 106 shown in FIG. 8 is exemplarily described for different times, namely the time instant 0, the time span from 0 to latency, the time instant latency, the time span from latency to SharedMemoryBlockSize and the time instant SharedMemoryBlockSize. Thereby, a memory area (of the memory 106), that can be shared or allows to fast-copy data, is used for loopback. In addition, an address (x) is defined where to start writing data into memory and a memory address (y) is set from where to use drive data from before loopback starts. Moreover, a Shared MemoryBlockSize for wrap-around of memory can be defined (this might depend on setup parameters, e.g. speed of capturing data from the device under test 104, memory access speed, etc.). In some embodiments, the wrap around concept according to the present invention states that regardless of the whether the automatic test equipment comprises one memory buffer (which is dual ported then) or two memory buffers, those will be limited in length. This means, from time to time they need to be re-used, the write pointer jumps back to the start address of the one memory or the start address of the alternate memory. There is a difference between write captured pointer and read out (drive) pointer to make sure the writing of data has completed. It contributes to the latency. In the case of memory copy sketched above this is true as well; the drive pointer works then as copy pointer. For the second memory a copy (from other memory) pointer and a drive back to device pointer can be used.

Time 0:
Write captured data into memory starting at address x
Drive pre-loopback data (e.g. break vectors) from memory

Time 0 . . . latency:
Continuously increase address for capturing data
Write captured data into memory

Time latency:
Write captured data into memory
Drive data written at time 0 from memory starting at address y

Time latency . . . SharedMemoryBlocksize
Continuously increase address n for capturing data and driving data
Write captured data into memory
Drive data from memory

Time SharedMemoryBlocksize
Write captured data into memory, wrap around for captured data, restart at address x
Drive data written at time SharedMemoryBlocksize—latency from memory

Time SharedMemoryBlocksize+latency
Write data into memory
Drive data written at time SharedMemoryBlockSize, wrap around for drive data, restart form address y

In the following, an example programming setup of the FIFO based memory allocation of the example shown in FIG. 8 is described.

Pin (a): Input pin

Pin (b): Output pin

Port (porta): contains pin (a)

Port (port_b): contains pin (b)
SETUP 1 “loopback_setup_test_i”
PINS a,b
LOOP_I; configures channels a and b as second channel 116 to drive the output signal 108
BRK CLK|HOLD; selects output signal 108, while loopback is not running
SETUP 2 “loopback_setup_test_o”
PINS c,d
LOOP_O; configures channels c and d as first channel 114 to receive the input signal 102
SETUP 3 “loopback_setup_test_diff_i”
PINS a@diff
LOOP_I; configures channels a and b as second channel 116 to drive output signal 108 as a differential channel
BRK CLK|HOLD
SETUP 4 “loopback_setup_test_diff_o”
PINS c@diff
LOOP_O; configures channels c and d as a first channel 114 to receive the input signal 102 as a differential channel

TIMINGSET 1 “loopback_tim”

PINS a, b, c, d

loopback_period=[period_spec]; defines the sampling period, at which the first channel 114 samples the input signal 102. Also defines the retiming period, at which the second channel 116 drives the output signal 108 to the DUT 104

Subsequently, advantages of the memory based loopback provided by the automatic test equipment 100 according to the concept of the present invention compared to state of the art loopback solutions are described.

An advantage of the memory based loopback is that hardware typically available in ATE systems (receiving, result capturing in memory, generate signals based on patterns in memory, shared memory) can be used independent of the availability of hardware loopback.

A further advantage of the memory based loopback is the flexibility of pin assignment for loopback. For example, it is possible to combine arbitrary pins as loopback that share the same memory 106 or can exchange memory content with a sufficient speed. In addition, the drive and receive channel 114 and 116 may swap direction on any given pair. This is very important to apply to parallel I/O of the device under test 104 (I/O=Input/Output).

Moreover, an advantage of the memory based loopback is the flexibility to use the same pin for drive/receive and loopback. The same pin can be used for digital drive/receive, PRBS generation/detection and as loopback (PBRS=Pseudo Random Bit Sequence). In addition, switching during test is possible.

A further advantage of the memory based loopback are additional hardware possibilities. For example, it is possible to make usage of all hardware possibilities in receive and drive paths 114 and 116 of the ATE channel, i.e. for drive path 114 jitter injection, retiming and equalization, and for the receive path 116 transition test and clock data recovery.

Furthermore, an advantage of the memory based loopback is the possibility of reuse in future products. For example, a loopback mode can be inherited by future products. Moreover, no special hardware support is required. In addition, no additional traces, connections and relays are necessary.

Moreover, an advantage of the memory based loopback is the possibility of an independent timing programming of the drive/receive channels 114 and 116. Independent programming of driver and receiver is also possible for the level programming. In contrast to that, an independent timing of the receive and drive part 114 and 116 of the loopback is not possible in load board based/parameterized loopback.

A further advantage of the memory based loopback is a constant latency. The latency between receiving 114 and driving 116 is a constant number of cycles independent of a tester period.

In embodiments, the drive data can be generated out of the captured data, i.e. the same fast convertible format can be used between memory data for capturing and vectors/signal generation. For example, in embodiments, the captured data can be interpreted directly as vectors without the need of processing. A clever wavetable setup can make this possible. Naturally, other implementation are also possible.

Furthermore, in embodiments with a limited memory size, a wrap-around of memory can be used to use the same memory area several times in order to deal with the limited memory size. For example, in embodiments, a double buffer approach can be used for capture and replay, wrap-around on capture buffer. This allows a continuous execution with only minimal memory requirement, e.g. with 8 k byte of memory used.

Moreover, in embodiments, the latency is the offset between write and read. Thereby, the memory 106 is not read before written, i.e. by latency between result capturing/signal generation and accessing both with the same speed. The latency between drive and receive paths 114 and 116 can be minimized to fit application needs.

Furthermore, in embodiments, the automatic test equipment 100 can switch between loopback mode and drive/receive mode. A criteria to end loopback mode and switch to drive/receive mode can be a predefined value for a number of loopback vectors or an auto-detect end of loopback based on the status of non-loopback pins/ports. In the latter, loopback may run till tasks running in parallel execution on other pins/ports are finished. This involves at least one non-loopback pin/port.

In embodiments, in order to deal with mid level/electrical idle, a dual threshold comparator can be used to detect and capture to memory and loop back mid level/electrical idle states. In this case, three states of the input signal can be captured and stored in two bits per sample.

Embodiments of the present invention provide a cost efficient structural test solution for high-speed interfaces. It enables serving test needs, e.g. for USB3, PCIe Gen. 2 and 3, SATA and other high-speed interfaces seen in many devices targeting consumer applications. Some embodiments of the present invention provide a structural (BIST driven) test approach without the need of having relay circuitry on the device interface board.

In some embodiments, the data from the device under test 104 can be captured in a buffer or memory 106, be processed with an embedded processor and then sent back to the device under test 104. Thereby, a continuous capture and replay without any intermediate processing steps is provided.

Further embodiments of the present invention provide a method for testing a device under test. In a first step, an input signal is received from the device under test and an information describing the input signal is written to a memory. In a second step, the information describing the input signal is read from the memory and an output signal is provided for the device under test based on the information describing the input signal read from the memory.

Further embodiments of the present invention provide an apparatus for configuring an automatic test equipment 100. The apparatus is adapted to configure the automatic test equipment 100 to receive an input signal 102 from a device under test 104 and to write an information describing the input signal 102 to a memory 106. The apparatus is further adapted to configure the automatic test equipment 100 to read the information describing the input signal 102 from the memory 106 and to provide an output signal 108 for the device under test 104 based on the information describing the input signal 102 read from the memory 106.

Further embodiments of the present invention provide a method for configuring an automatic test equipment. In a first step, the automatic test equipment is configured to receive an input signal from a device under test and to write an information describing the input signal to a memory. In a second step, the automatic test equipment is configured to read the information describing the input signal from the memory and to provide an output signal for the device under test based on the information describing the input signal read from the memory.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An automatic test equipment,
wherein the automatic test equipment is configured to receive an input signal from a device under test and to write an information describing the input signal to a memory; and
wherein the automatic test equipment is configured to read the information describing the input signal from the memory and to provide an output signal for the device under test based on the information describing the input signal read from the memory; and
wherein the device under test comprises a built in self test unit, wherein the automatic test equipment is coupled to the device under test to receive a signal provided by the built in self test unit as the input signal and to provide the output signal to the built in self test unit.

2. The automatic test equipment according to claim 1, wherein the output signal is a loopback of the input signal.

3. The automatic test equipment according to claim 1, wherein the automatic test equipment is configured to write the information describing the input signal to the memory such that the information describing the input signal are vectors describing the input signal.

4. The automatic test equipment according to claim 1, wherein an input path of the automatic test equipment is configured to convert the input signal into a digital signal using an adjustable sample frequency and an adjustable threshold level in order to aquire the information describing the input signal, and wherein an output path of the automatic test equipment is configured to provide the output signal using an adjustable clock edge and an adjustable signal level based on the information describing the input signal read from the memory.

5. The automatic test equipment according to claim 1, comprising:
a first channel configured to receive the input signal from the device under test and to write the information describing the input signal to the memory; and
a second channel configured to read the information describing the input signal from the memory and to provide the output signal for the device under test based on the information describing the input signal read from the memory.

6. The automatic test equipment according to claim 1, comprising:
a first channel configured to receive the input signal from the device under test and to write the information describing the input signal to the memory;
a second memory linked to the first memory for copying the information describing the input signal from the memory to the second memory;
a second channel configured to read the information describing the input signal from the second memory and to provide the output signal for the device under test based on the information describing the input signal read from the second memory.

7. The automatic test equipment according to claim 5, wherein the first channel and/or the second channel are differential channels.

8. The automatic test equipment according to claim 5, wherein the first channel and/or the second channel are bidirectional channels.

9. The automatic test equipment according to claim 1, comprising a measurement unit for measuring a parameter of the input signal.

10. The automatic test equipment according to claim 9, wherein the measurement unit is configured to perform a functional test or parametric measurement.

11. The automatic test equipment according to claim 1, comprising a modification unit for modifying a parameter of the output signal.

12. The automatic test equipment according to claim 11, wherein the modification unit is configured to perform a jitter injection and/or skew injection.

13. The automatic test equipment according to claim 1, comprising a retiming unit for detecting a timing of the input signal and for retiming the output signal.

14. The automatic test equipment according to claim 1, comprising an equalization unit for equalizing the input-signal and/or an equalization unit for equalizing the output signal.

15. A method for testing a device under test comprising a built in self test unit, the method comprising:
receiving an input signal from the device under test and writing an information describing the input signal to a memory; and
reading the information describing the input signal from the memory and providing an output signal for the device under test based on the information describing the input signal read from the memory;
wherein receiving the input signal comprises receiving a signal provided by the built in self test unit as the input signal; and
wherein providing the output signal comprises providing the output signal to the built in self test unit of the device under test.

16. A computer program for testing a device under test, the computer program comprising a program code for performing, when running on a computer or microprocessor, a method according to claim 15.

17. An apparatus for configuring an automatic test equipment,
wherein the apparatus is adapted to configure the automatic test equipment to receive an input signal from a device under test and to write an information describing the input signal to a memory; and
wherein the apparatus is adapted to configure the automatic test equipment to read the information describing the input signal from the memory and to provide an output signal for the device under test based on the information describing the input signal read from the memory; and
wherein the device under test comprises a built in self test unit, wherein the automatic test equipment is coupled to the device under test to receive a signal provided by the built in self test unit as the input signal and to provide the output signal to the built in self test unit.

18. A method for configuring an automatic test equipment, the method comprising:
configuring the automatic test equipment to receive an input signal from a device under test and to write an information describing the input signal to a memory; and
configuring the automatic test equipment to read the information describing the input signal from the memory and to provide an output signal for the device under test based on the information describing the input signal read from the memory;
wherein the device under test comprises a built in self test unit, wherein the automatic test equipment is coupled to the device under test to receive a signal provided by the built in self test unit as the input signal and to provide the output signal to the built in self test unit.

19. A computer program for configuring an automatic test equipment, the computer program comprising a program code for performing, when running on a computer or microprocessor, a method according to claim 18.

20. An automatic test equipment system comprising an automatic test equipment according to claim 1 and a device under test, wherein the device under test comprises a built in self test unit, wherein the automatic test equipment is coupled to the device under test to receive a signal provided by the built in self test unit as the input signal and to provide the output signal to the built in self test unit.
